(19) United States
(12) Patent Application Publication
(10) Pub. No.: US 2025/0265403 A1
(43) Pub. Date: Aug. 21, 2025

(54) METHODS FOR MODELING CMOS TRANSISTOR CHARACTERISTICS IN CRYOGENIC CONDITIONS

(71) Applicant: Foundation of Soongsil University-Industry Cooperation, Seoul (KR)

(72) Inventors: Young-Ha Hwang, Seoul (KR); Seunghoon Yi, Seoul (KR); Seung Chae Jung, Seoul (KR); Hee-Cheol Joo, Seoul (KR); Yoochang Kim, Seoul (KR)

(21) Appl. No.: 19/022,246

(22) Filed: Jan. 15, 2025

(30) Foreign Application Priority Data
Feb. 16, 2024 (KR) 10-2024-0022639

(51) Int. Cl. G06F 30/367; G06F 117/12; G06F 119/08; G06F 119/14

(52) U.S. Cl. CPC G06F 30/367; G06F 2117/12; G06F 2119/08; G06F 2119/14

(57) ABSTRACT

Proposed is a method of modeling characteristics of a CMOS transistor in cryogenic conditions on the basis of a PSP model, and the method includes receiving a process design kit (PDK) comprising device information and process information, which are required for designing and implementing an integrated circuit, extracting at least one parameter for modeling a prediction model for predicting characteristic values of a device comprised in the integrated circuit in cryogenic conditions from the PDK, and modeling the prediction model by adjusting the at least one parameter, so as to predict the characteristic values of the device in cryogenic conditions.

### CROSS REFERENCE TO RELATED APPLICATION

The present application claims priority to Korean Patent Application No. 10-2024-0022639, filed Feb. 16, 2024 the entire contents of which are incorporated herein for all purposes by this reference.

### BACKGROUND

### Field of the Invention

The present disclosure relates to a system and a method thereof for modeling characteristics of a CMOS transistor in cryogenic conditions on the basis of a PSP model and a method for simulating and correcting characteristics of a CMOS transistor in cryogenic conditions on the basis of a PSP model.

### Description of the Related Art

Quantum computing is a computing method that utilizes quantum phenomena, and has excellence (quantum superiority) that may solve certain types of problems including large-scale data and the like more quickly than classical computing. The basic unit of quantum computing is called a qubit, and although there are some differences according to qubit types and physical implementation methods, a quantum computer operates in a cryogenic range of a few Kelvin or less. The methods of implementing a quantum computer may be largely divided according to the qubit types, the physical implementation methods, and the methods of controlling qubit operations. Among these methods, a method of controlling the qubit operations based on complementary metal-oxide-semiconductor (CMOS) transistors utilizing commercial foundry process is suitable for implementing high-integration, high-scalability quantum computers, but there is a technical difficulty in that the CMOS transistors should also operate in the cryogenic range for qubit control.

Process design kits (PDKs) provided by foundries are typically based on the results of transistor characteristic measurement over a temperature range of −40 to 125 degrees Celsius, ensuring reliable simulation data over the corresponding temperature range. That is, in cryogenic conditions where quantum computing is performed, the characteristic simulation data is unreliable for complementary metal-oxide-semiconductor (CMOS) transistors.

There are various previous studies to overcome such a problem, but the reality is that the reliability of characteristic prediction for each transistor size in cryogenic conditions is low.

### SUMMARY

An objective of the present disclosure for solving the technical problem is to provide a method including: extracting global parameters related to characteristic values that vary depending on geometry of a complementary metal-oxide-semiconductor (CMOS) transistor; modeling a characteristic value prediction model by adjusting the global parameters; and predicting the characteristic values of the CMOS transistor in cryogenic conditions.

In addition, another objective of the present disclosure for solving the technical problem is to provide a method including: extracting parameters related to characteristic values that vary depending on cryogenic conditions of a complementary metal-oxide-semiconductor (CMOS) transistor; modeling a characteristic value prediction model by adjusting the parameters; and predicting the characteristic values of the CMOS transistor in cryogenic conditions.

According to exemplary embodiments, there is provided a method of modeling characteristics of a CMOS transistor in cryogenic conditions on the basis of a PSP model, the method including: receiving a process design kit (PDK) including device information and process information, which are required for designing and implementing an integrated circuit; extracting at least one parameter for modeling a prediction model for predicting characteristic values of a device included in the integrated circuit in the cryogenic conditions from the PDK on the basis of the PSP model; and modeling the prediction model by adjusting the at least one parameter, so as to predict the characteristic values of the device in the cryogenic conditions.

Here, the device may be the complementary metal-oxide-semiconductor (CMOS) transistor.

Here, the model may be the PSP model and may be configured to perform steps including: performing geometry scaling for setting global parameters; modeling a stress model by setting stress parameters; modeling a well proximity effect model by setting well proximity effect parameters; performing temperature scaling by setting local parameters; and predicting the characteristic values of the device by inputting terminal voltages into equations for the model.

Here, the extracting of the at least one parameter may include: extracting at least one first parameter dependent on geometric properties of the device among the parameters utilized in the PSP model; and extracting at least one second parameter dependent on temperature properties of the device among the parameters utilized in the PSP model.

Here, the modeling of the prediction model may include: adjusting the first and second parameters so as to be suitable for predicting the characteristic values of the device in the cryogenic conditions; and implementing the performing of the geometry scaling, the modeling of the stress model, the modeling of the well proximity effect model, and the performing of the temperature scaling on the basis of the adjusted first and second parameters.

Here, the extracting of the at least one parameter may include: extracting device characteristics that are affected and changed by the cryogenic conditions; extracting at least one third parameter dependent on the characteristics among the parameters utilized in the PSP model; adjusting the third parameters so as to be suitable for predicting the characteristic values of the device in the cryogenic conditions; and implementing the performing of the geometry scaling, the modeling of the stress model, the modeling of the well proximity effect model, and the performing of the temperature scaling on the basis of the adjusted third parameters.

Here, there is provided a computer-readable recording medium, including a program recorded thereon for executing a method for modeling characteristics of a CMOS transistor in cryogenic conditions on the basis of a PSP model.

According to the exemplary embodiments, there is provided a system for modeling characteristics of a CMOS transistor in cryogenic conditions on the basis of a PSP model, the system including: at least one processor for implementing the system, wherein the at least one processor may be configured to receive a process design kit (PDK) including device information and process information, which are required for designing and implementing an integrated circuit, extract at least one parameter for modeling a prediction model for predicting characteristic values of a device included in the integrated circuit in the cryogenic conditions from the PDK, and model the prediction model by adjusting the at least one parameter, so as to predict the characteristic values of the device in the cryogenic conditions.

According to the exemplary embodiments, there is provided a method for simulating and correcting characteristics of a CMOS transistor in cryogenic conditions on the basis of a PSP model, the method including: receiving a process design kit (PDK) including device information and process information, which are required for designing and implementing an integrated circuit; extracting at least one parameter for modeling a prediction model capable of simulating and correcting a geometry dependent effect according to changes in characteristic values of a device included in the integrated circuit in the cryogenic conditions from the PDK on the basis of the PSP model; and modeling the prediction model by adjusting the at least one parameter, so as to simulate and correct a geometry dependent effect in the cryogenic conditions.

According to the present disclosure, the system and the method thereof for modeling the characteristics of the CMOS transistor in cryogenic conditions on the basis of the PSP model and the method for simulating and correcting the characteristics of the CMOS transistor in cryogenic conditions on the basis of the PSP model may extract the global parameters related to the characteristic values that vary depending on the geometry of the complementary metal-oxide-semiconductor (CMOS) transistor, model the characteristic value prediction model by adjusting the global parameters, and predict the characteristic values of the CMOS transistor in cryogenic conditions.

In addition, according to the present disclosure, the system and the method thereof for modeling the characteristics of the CMOS transistor in cryogenic conditions on the basis of the PSP model and the method for simulating and correcting the characteristics of the CMOS transistor in cryogenic conditions on the basis of the PSP model may extract the parameters related to the characteristic values that vary depending on cryogenic conditions of the complementary metal-oxide-semiconductor (CMOS) transistor, model the characteristic value prediction model by adjusting the parameters, and predict the characteristic values of the CMOS transistor in cryogenic conditions.

In this way, the embodiment of the present disclosure may not only accurately predict the characteristic values of a CMOS transistor by controlling a smaller number of parameters in cryogenic conditions, but also utilize existing circuit design methods and processes, as they are, on the basis of the existing process design kits (PDKs).

### BRIEF DESCRIPTION OF THE DRAWINGS

FIGS. 1A, 1B and 1C are views illustrating a PSP model and an operation of a CMOS transistor in cryogenic conditions according to an exemplary embodiment of the present disclosure.

FIG. 2 is a flowchart illustrating a method for modeling characteristics of a CMOS transistor in cryogenic conditions on the basis of a PSP model according to the exemplary embodiment of the present disclosure.

FIG. 3 is a view illustrating a parameter extraction process and control for the characteristic modeling in cryogenic conditions according to the exemplary embodiment of the present disclosure.

FIG. 4 is a table illustrating comparisons between other modeling methods and the characteristic modeling method according to the exemplary embodiment of the present disclosure.

FIGS. 5A and 5B are views illustrating an example of experimental results regarding the characteristics of the CMOS transistor according to adjusted parameters according to the exemplary embodiment of the present disclosure.

FIGS. 6A, 6B and 6C are views illustrating a CMOS modeling method using a ring oscillator and experimental results thereof according to the exemplary embodiment of the present disclosure.

FIGS. 7A, 7B and 7C are views illustrating a parameter extraction process and control for characteristic modeling in cryogenic conditions according to another exemplary embodiment of the present disclosure.

### DETAILED DESCRIPTION OF EXEMPLARY EMBODIMENTS

Hereinafter, various exemplary embodiments of the present disclosure will be described in detail with reference to the accompanying drawings so that those skilled in the art may easily implement the present disclosure. The embodiments of the present disclosure are not limited to the exemplary embodiments described herein and may be embodied in many different forms.

In order to clearly describe the present disclosure, parts irrelevant to the description are omitted, and the same reference numerals designate the same or similar components throughout the specification. Therefore, the reference symbols described above may also be used in other drawings.

In addition, the size and thickness of each component shown in the drawings or views are arbitrarily represented for convenience of description, so the embodiments of the present disclosure are not necessarily limited to the illustrated drawings or views. The thickness may be exaggerated to clearly represent multiple layers and areas in the drawings.

In addition, the expression “same” in the description may mean “substantially the same”. That is, this may be meant to be an expression on semantic sameness to the extent that a person with common knowledge may be convinced that it is the same. Other expressions may also be expressions that omit “substantially”.

In addition, when a part is said to “include” or “comprise” a certain component in the description herein, it means that the part may further include or comprise another component, rather than excluding another component unless the context clearly indicates otherwise. As used in the present specification, the term “˜part/unit” refers to a unit for processing at least one function or operation, and may mean, for example, software, an FPGA, or a hardware component. The functions provided by “˜unit” may be performed separately by a plurality of components, or may also be integrated with other additional components. The term “˜part” or “˜unit” is not necessarily limited to software or hardware, and may be configured to reside in an addressable storage medium or may also be configured to operate one or more processors. Hereinafter, the exemplary embodiments of the present disclosure will be described in detail with reference to the drawings.

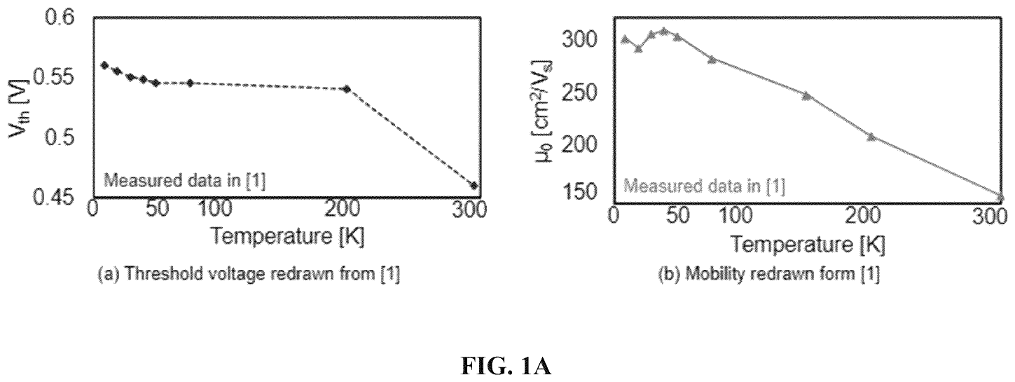

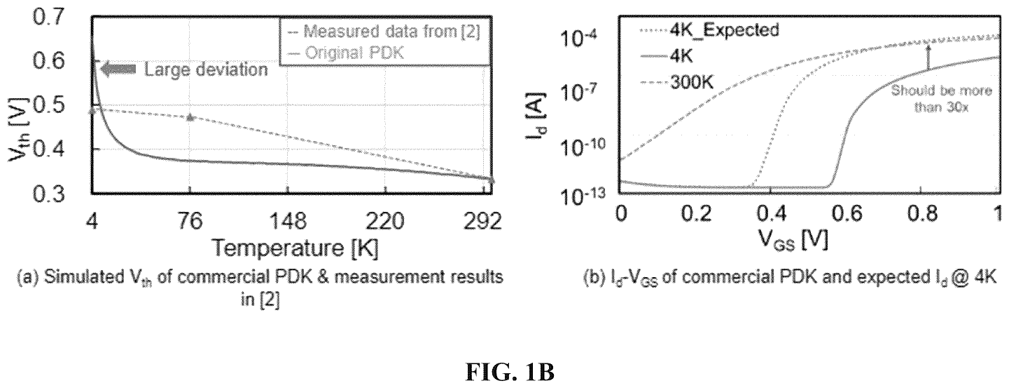

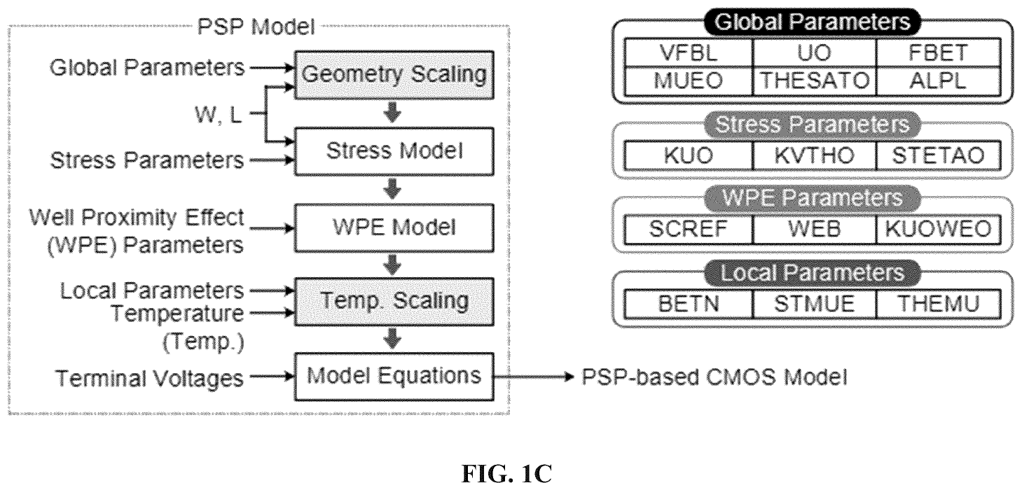

FIGS. 1A to 1C are views illustrating a PSP model and an operation of a CMOS transistor in cryogenic conditions according to an exemplary embodiment of the present disclosure.

View (a) in FIG. 1A shows how threshold voltage V_th changes depending on temperature. Referring to view (a) in FIG. 1A, it may be seen that the threshold voltage increases as the temperature [K] decreases.

View (a) in FIG. 1A shows how mobility μ changes depending on temperature. Referring to view (a) in FIG. 1A, the mobility tends to increase as the temperature decreases.

That is, the characteristics of a CMOS transistor change more significantly as temperature therefor changes from a room temperature of 300K to cryogenic conditions (a temperature of 4K or less), meaning that this fact is an important consideration in circuit design based on CMOS transistors for the qubit control.

Typical existing process design kits (PDKs) ensure reliable simulation data in a temperature range of −40° C. to 125° C. However, referring to view (a) in FIG. 1B, it may be seen that threshold voltage V_th of the existing process design kits (Original PDKs) increases excessively near at 4K. This causes a difference from actual measured data (Measured data from [2]).

Referring to view (a) in FIG. 1B, it may be seen that predicted data (a red dotted line) shows a large deviation at low temperatures (around 4K) compared to the typical existing process design kits (PDKs, a blue solid line). That is, it may be seen that the existing PDK model is unable to accurately predict current Id of a CMOS transistor at cryogenic temperatures.

Meanwhile, referring to the red dotted line and blue solid line in view (b) in FIG. 1B together, it may be seen that although the increase (4K Expected) in expected mobility μ should be approximately 30 times or more in values of current, there are large differences between the actual measured data (a blue curve) and the expected data (a red dotted line).

As described above, the existing process design kits (PDKs) have difficulty in accurately predicting how the CMOS transistor operates at the cryogenic temperatures, and thus, it may be seen that the method of simulating and modeling the cryogenic characteristics, the method enabling correction for this difficulty, is required. In particular, this is especially important when designing CMOS-based controller ICs that should operate at cryogenic conditions.

FIG. 1C is a view illustrating a model called a PSP model among CMOS transistor compact models. The PSP model is available for 40 nanometer (nm) or smaller process technology in commercial process design kits (PDKs).

The PSP model may be composed of several parameters, such as global parameters (Global Parameters), stress parameters (Stress Parameters), well proximity effect parameters (WPE Parameters), and local parameters (Local Parameters).

The global parameters (Global Parameters) are parameters that determine the fundamental characteristics and operation of a transistor, and may include geometry scaling (Width W and Length L), threshold voltage variation, etc.

The stress parameters are parameters that model the impact of mechanical stress on the characteristics of the transistor, and may have a significant impact on the reliability and performance of a device.

The well proximity effect parameters (WPE Parameters) are parameters that indicate well proximity effects and may describe electrical characteristics that change depending on proximity to a well of a transistor.

The local parameters (Local Parameters) are parameters that indicate changes in the transistor characteristics depending on temperatures, and are applied to a model through temperature scaling (Temp and Scaling).

Such parameters may ultimately be used in model equations that affect the terminal voltages of a transistor. In this way, the actual behavior of the transistor becomes predictable, and characteristic changes due to temperature changes may also be predicted through a temperature scaling model that considers temperature-dependent changes.

However, as described above, in the case of such a PSP model of commercial foundry CMOS process PDKs, the characteristic changes of a CMOS transistor at cryogenic temperatures are not properly modeled, and the previous studies to solve this problem also have limitations in applying differences in geometry dependent characteristics according to the size (Width and Length) of the CMOS transistor at the cryogenic temperatures.

In addition, in the previous studies, a large number of parameters should be adjusted in order to apply the characteristics of a CMOS transistor in cryogenic conditions, so there is a disadvantage in that the number of required measurements and the number of repetitions increase.

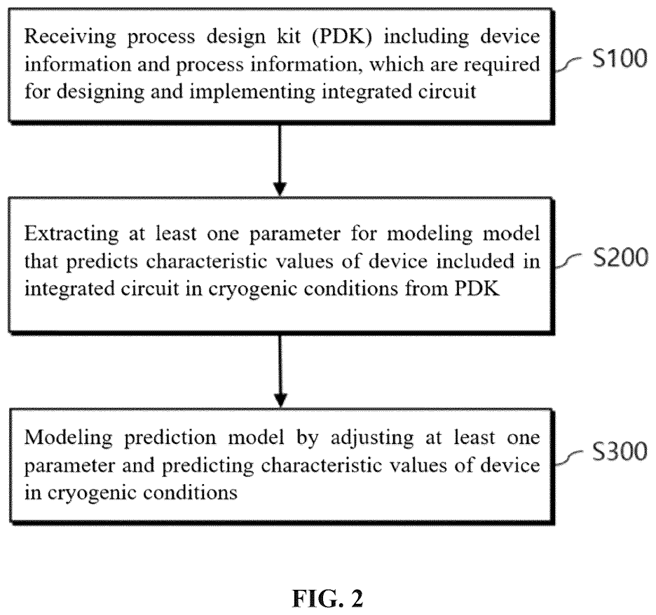

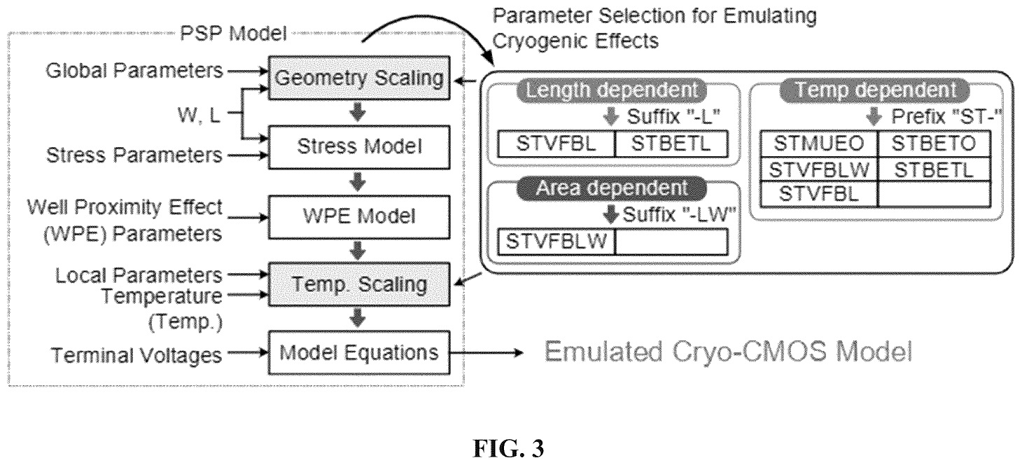

FIG. 2 is a flowchart illustrating a method for modeling characteristics of a CMOS transistor in cryogenic conditions on the basis of a PSP model according to the exemplary embodiment of the present disclosure. FIG. 3 is a view illustrating a parameter extraction process and control for characteristic modeling in cryogenic conditions according to the exemplary embodiment of the present disclosure.

The method and the system thereof for modeling the characteristics of the CMOS transistor in cryogenic conditions on the basis of the PSP model according to the exemplary embodiment of the present disclosure may be implemented or operated by at least one processor.

Hereinafter, the following description will be given with reference to FIGS. 2 and 3.

In step S100, there may be provided a PDK requiring device information and process information, which are required for designing and implementing an integrated circuit.

In this case, a device may be a complementary metal-oxide-semiconductor (CMOS) transistor.

In step S200, at least one parameter for modeling a model that predicts characteristic values of the device included in the integrated circuit in cryogenic conditions may be extracted from the PDK on the basis of a PSP model.

Referring to FIG. 3, at least one processor may extract at least one parameter (hereinafter referred to as first parameters), which is dependent on geometric properties (e.g., Width W and Length L) of the device, among the parameters utilized in the PSP model.

For example, the at least one processor may extract at least one first parameter related to a length dependent effect. In order to apply such an effect, the first parameters may be parameters using a “-L” suffix, and are illustrated as STVFBL and STBETL in FIG. 3, but are not limited thereto.

Alternatively, the at least one processor may extract at least one first parameter related to an area dependent effect. In order to apply such an effect, the first parameters may be parameters using a “-LW” suffix, and are illustrated as “STVFBLW” in FIG. 3, but are not limited thereto.

Alternatively, the at least one processor may extract at least one second parameter related to a temperature dependent effect. In order to apply such an effect, the second parameters may be parameters using a “ST-” prefix, and are illustrated as “STMUEO, STBETO, STVFBL, and STBETL” in FIG. 3, but are not limited thereto.

The at least one processor may adjust the at least one first parameter related to the length dependent effect, the at least one first parameter related to the area dependent effect, and the at least one second parameter related to the temperature dependent effect. These parameters may affect steps including: performing geometry scaling, modeling a stress model, modeling a well proximity effect model, performing temperature scaling, and predicting device characteristic values by inputting equations for the models.

Specifically, the at least one processor is capable of adjusting the first and second parameters so as to be suitable for predicting characteristics of a CMOS transistor at cryogenic temperatures, and may perform the various steps based thereon.

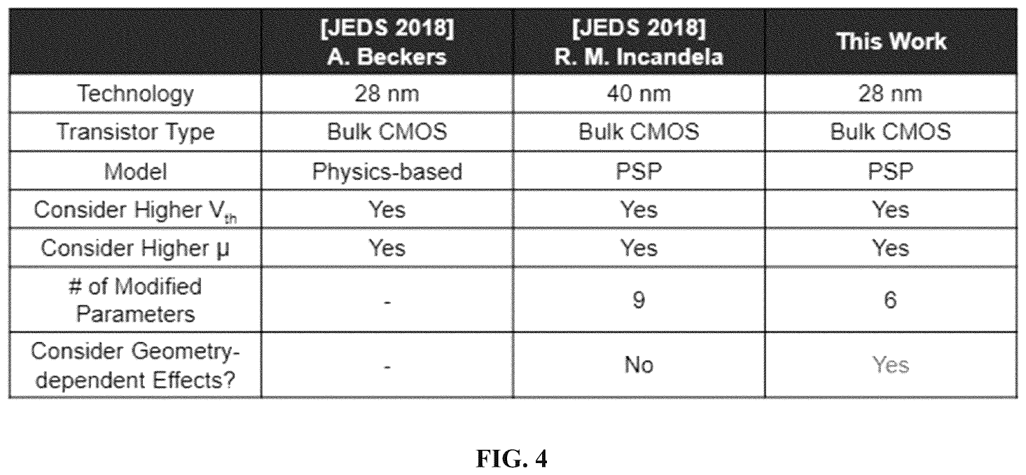

FIG. 4 is a table illustrating comparisons between other modeling methods and the characteristic modeling method according to the exemplary embodiment of the present disclosure.

As a result of conducting an experiment according to the system and the method thereof for modeling the characteristics of the CMOS transistor in cryogenic conditions on the basis of the PSP model of the present disclosure, it may be seen that the number of parameters (# of Modified Parameters) required to predict the characteristic values of the CMOS transistor in cryogenic conditions is smaller than that of other existing models (i.e., a model of A. Beckers and a model of R.M. Incandela).

For example, the model of A. Beckers is not suitable for predicting the characteristics of a CMOS transistor in cryogenic conditions even when the parameters are adjusted. In addition, in the case of the model of R.M. Incandela, it may be seen that the number of parameters, which is nine, required to be adjusted to predict the characteristic values of the CMOS transistor in cryogenic conditions is more than the number of parameters, which is six, required to be adjusted in the system and the method thereof for modeling the characteristics of the CMOS transistor in cryogenic conditions on the basis of the PSP model of the present disclosure.

In addition, as the result of conducting the experiment in accordance with the system and the method thereof for modeling the characteristics of the CMOS transistor in cryogenic conditions on the basis of the PSP model of the present disclosure, it may be seen that the embodiment of the present disclosure considers geometry dependent effects at the cryogenic temperatures in order to predict the characteristics of the CMOS transistor in cryogenic conditions compared to other existing models (i.e., the models of A. Beckers and R.M. Incandela).

That is, the embodiment of present disclosure requires a fewer number of parameter modifications when compared to other methods, and may apply a geometry dependent effect and a temperature dependent effect. In this way, it may be seen that the embodiment of the present disclosure is a more concise and efficient modeling method and may be useful for designs using CMOS technology in cryogenic environments.

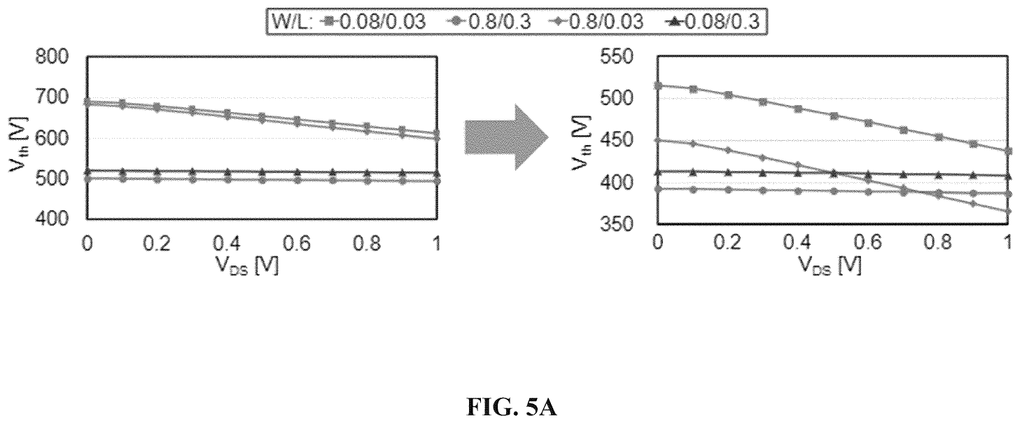

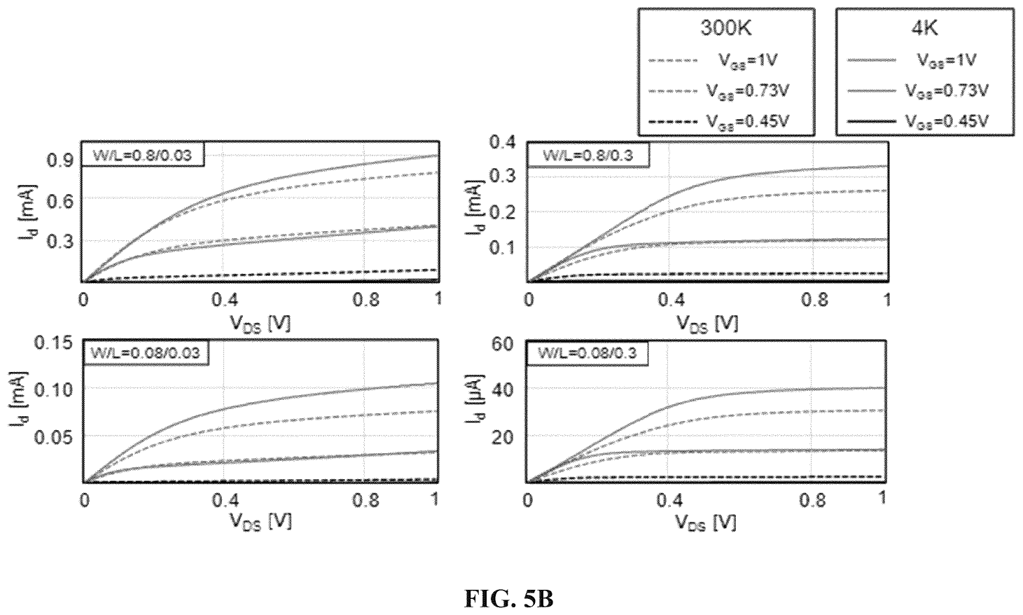

FIGS. 5A and 5B are views illustrating an example of experimental results regarding the characteristics of the CMOS transistor according to adjusted parameters according to the exemplary embodiment of the present disclosure.

FIG. 5A illustrates an experimental result for threshold voltage V_th among characteristic values of a CMOS transistor, and FIG. 5B illustrates an experimental result for mobility μ among the characteristic values of the CMOS transistor.

Referring to FIG. 5A, the at least one processor adjusts the first and second parameters respectively related to geometric properties (e.g., Width W and Length L) and a temperature dependent effect of a device, so that changes in Vth depending on Vds voltage occur for CMOS transistors having various ratios of widths W to lengths L.

Compared to a graph on the left (for an existing PDK-based simulation result) where threshold voltage Vth is predicted to be excessively high, it may be confirmed that in a graph on the right (in a case of being applied with the embodiment of the present disclosure), threshold voltage Vth is predicted to be similar to an actual measurement result shown in the results of previous study.

In this way, it may be seen that in a case where the embodiment of the present disclosure is applied to the commercial foundry CMOS process PDKs, the threshold voltage Vth predicted to be excessively high in the simulation assuming cryogenic conditions may be corrected, so that more realistic CMOS transistor characteristics is predictable.

Referring to FIG. 5B, the at least one processor adjusts parameters STBETO and STMUEO related to the geometry independent effect affecting mobility μ in cryogenic conditions and adjusts parameters STBETL dependent on length L, thereby showing a change in drain current Id depending on drain voltage Vds at temperatures of 300K and 4K.

The characteristic values of transistors with W/L ratios different from each other may be compared with each other at 300K and 4K (in cryogenic conditions). Referring to the four graphs in FIG. 5B, a higher drain current Id is measured in the case of 4K compared to the case of 300K at the same drain voltage Vds. It may be seen that this shows the improved electrical performance of the CMOS transistors at the cryogenic temperatures.

That is, when the parameters STBETO and STMUEO related to the geometry independent effect and the parameter STBETL dependent to length L are adjusted, such as a case where W/L ratios are 0.8/0.03, 0.08/0.03, 0.8/0.3, and 0.08/0.3, it may be seen that it is suitable to predict the characteristic values of the CMOS transistors in cryogenic conditions

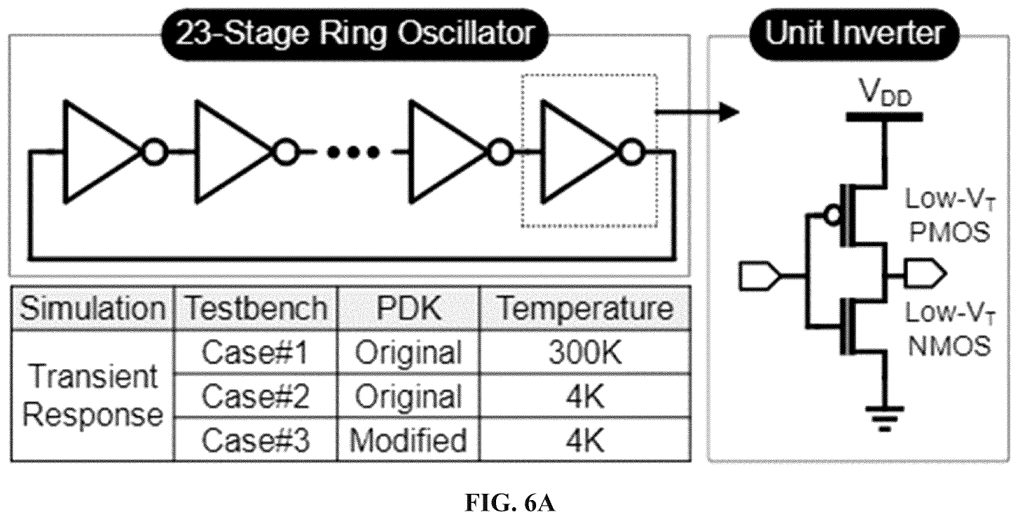

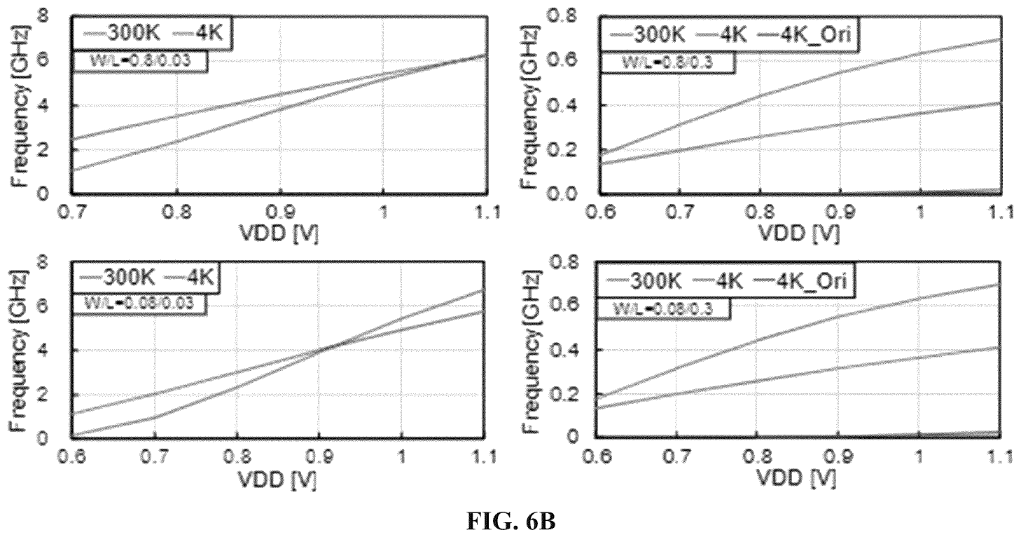

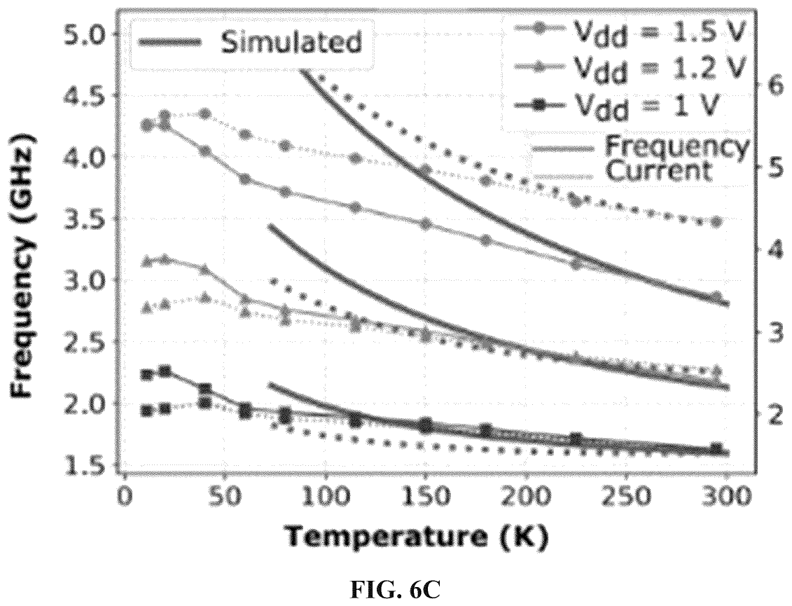

FIGS. 6A to 6C are views illustrating a CMOS modeling method using a ring oscillator and experimental results thereof according to the exemplary embodiment of the present disclosure.

FIG. 6A is a view illustrating a 23-stage ring oscillator (RO) designed on the basis of a CMOS transistor.

FIG. 6A shows experiment results conducted on the 23-stage ring oscillator at 300K (room temperature) and 4K (cryogenic conditions) in two divided cases: a case of simulation using typical process design kits (PDKs, Original); and a case of simulation using a model corrected according to the system and the method thereof for modeling the characteristics of the CMOS transistor in the cryogenic conditions on the basis of the PSP model according to the present disclosure (Modified PDK).

Referring to FIG. 6B, the two graphs on the left show oscillation frequencies according to VDD at W/L ratios different from each other. In the case where the simulation is performed at 4K (the cryogenic conditions) using the typical process design kits (PDKs, Original), it may be confirmed that the ring oscillator (RO) does not oscillate. This may be due to the threshold voltage Vth of a transistor being predicted excessively high in an existing PDK.

The two graphs on the right in FIG. 6B are the experimental results of the simulation (red lines in the graphs) using the typical process design kits (PDKs, Original) at 300K (the room temperature) and simulation (green lines in the graphs) using the typical process design kits (PDKs, Original) at 4K (the cryogenic conditions) in FIG. 6A, and the simulation (blue lines in the graphs) using the embodiment of the present disclosure at 4K (the cryogenic conditions). In the case where the simulation is performed at 4K (the cryogenic conditions) using the typical process design kits (PDKs, Original), it may be confirmed that the oscillation frequencies of the ring oscillator (RO) are predicted to be excessively low. This may be due to the existing PDK that predicts the threshold voltage Vth of the transistor too high or predict the mobility too low.

Meanwhile, in the case of applying the geometry dependent effects according to the present disclosure, it may be seen that the ring oscillator (RO) oscillates at 4K (the cryogenic conditions) (indicated in the blue lines in the graphs), and this may solve problems that may occur when simulation is performed by using only the existing typical process design kits (PDKs, Original).

Referring to the measurement results in FIG. 6C, which are the results of the previous studies, it may be seen that the frequency increases as the temperature decreases. That is, since the frequency is relatively high at low temperatures, it may be seen that the lower the temperature, the faster the speed of the oscillator. It may be confirmed that the simulation method according to the present disclosure allows that matching is performed well with actual measurement data.

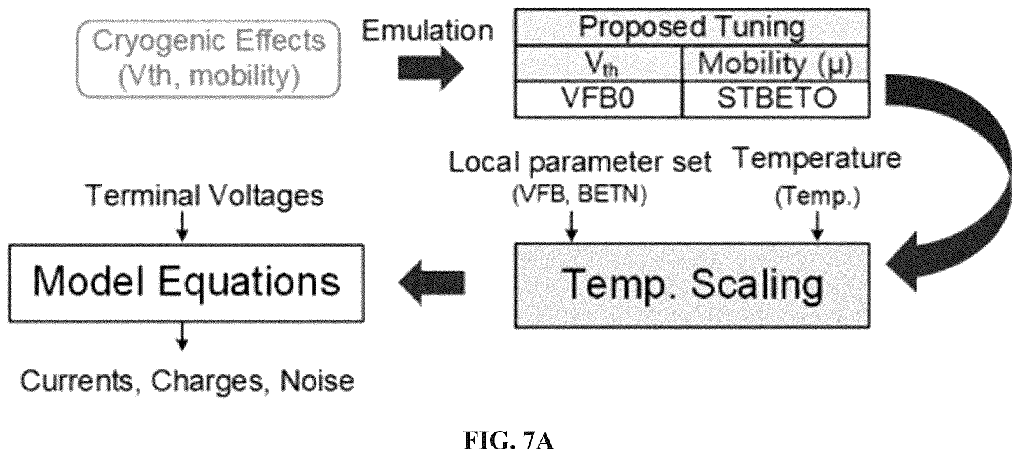

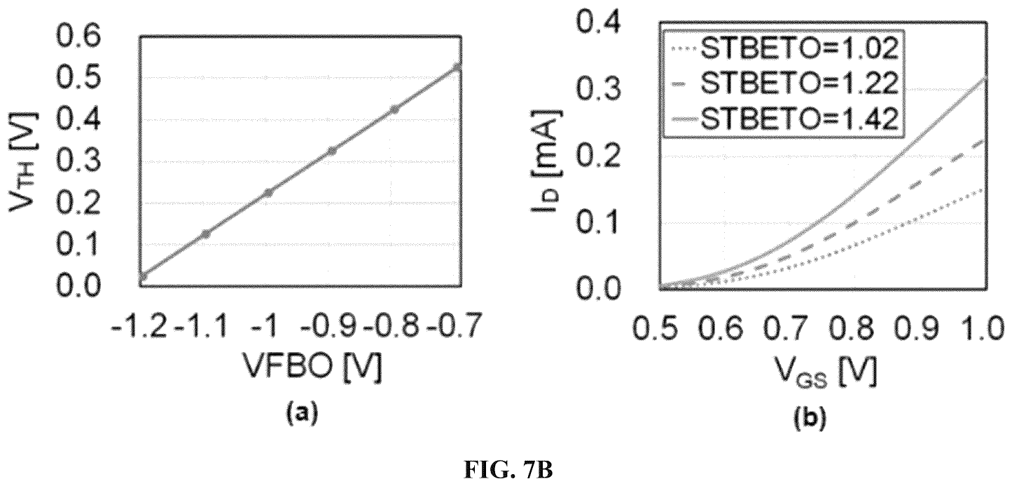

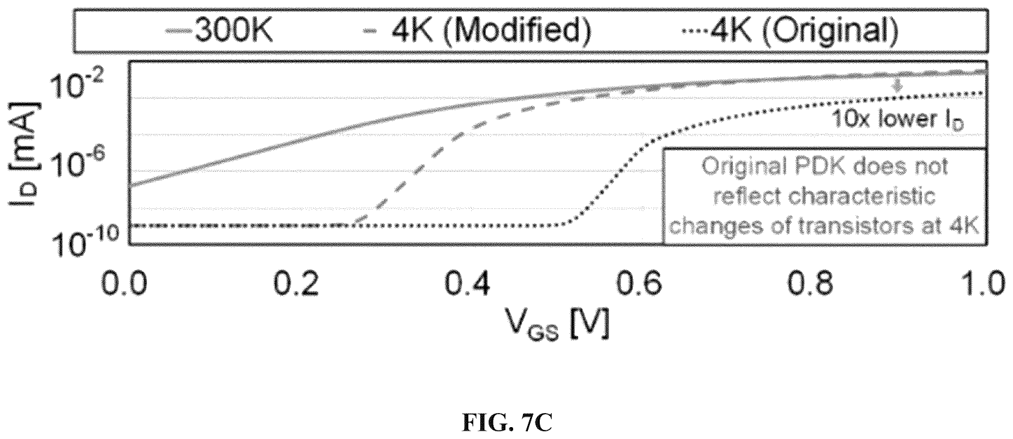

FIGS. 7A to 7C are views illustrating a parameter extraction process and control for characteristic modeling in cryogenic conditions according to another exemplary embodiment of the present disclosure.

Referring to FIG. 7A, the at least one processor may extract at least one parameter (hereinafter referred to as third parameters), which are dependent on cryogenic effects, among the parameters utilized in the PSP model.

For example, the at least one processor may extract at least one third parameter (VFB0 in FIGS. 7A to 7C) related to threshold voltage V_th. The at least one processor may extract at least one third parameter (STBETO in FIGS. 7A to 7C) related to mobility μ.

The at least one processor may adjust the at least one third parameter (VFB0 and STBETO in FIGS. 7A to 7C) related to the cryogenic effects, and this may affect the performing of the temperature scaling.

Specifically, the at least one processor is capable of adjusting the third parameters so as to be suitable for predicting characteristics of a CMOS transistor in cryogenic conditions, and may perform the various steps based thereon.

Referring to view (a) in FIG. 7B, threshold voltage Vth may be linearly changed by adjusting the VFBO parameter. Referring to view (b) in FIG. 7B, it may be seen that drain current I_D increases as the STBETO parameter increases. That is, the higher the mobility, the higher the drain current flows at the same gate voltage V_GS.

Referring to FIG. 7C, there are shown the results (4K, Original) of simulation using existing commercial process design kits (PDKs) at 4K (cryogenic conditions) and the results (4K, Modified) of simulation according to the present disclosure.

It may be seen that at 4K (the cryogenic conditions), the existing commercial process design kits (PDKs) are not applied with the characteristic changes of the CMOS transistor in the cryogenic conditions, whereby the threshold voltage Vth is predicted to be excessively high and the mobility μ is predicted to be excessively low.

In contrast, it may be seen that the results (4K, Modified) of the simulation according to the present disclosure are relatively well applied with the characteristic changes of the CMOS transistor in the cryogenic conditions.

As described above in FIGS. 7A to 7C, compared to the exemplary embodiment of the present disclosure described above in FIG. 4, another exemplary embodiment of the present disclosure has a smaller number of parameters (# of Modified Parameters) required to predict the characteristic values of a CMOS transistor in cryogenic conditions.

That is, compared to FIG. 4, there are effects shown in FIGS. 7A to 7C that the changes in the characteristic values of the CMOS transistor in cryogenic conditions may be relatively accurately simulated by adjusting only two parameters (VFB0 and STBETO).

The drawings referenced so far and the detailed description of the disclosure are merely illustrative of the present disclosure, which are only used for the purpose of describing the present disclosure, and it is not used to limit the meaning or the scope of the present disclosure described in the claims. Accordingly, those skilled in the art will appreciate that various modifications and other equivalent embodiments are possible. Therefore, the true technical protection scope of the present disclosure will be defined by the technical idea of the appended patent claims.

The exemplary embodiments described above may be implemented as a hardware component, a software component, and/or a combination of the hardware component and the software component. For example, devices and components described in the exemplary embodiments may be implemented by using one or more general purpose computers or special purpose computers, including, for example, a processor, a controller, an arithmetic logic unit (ALU), a digital signal processor, a microcomputer, a field programmable gate array (FPGA), programmable logic unit (PLU), microprocessor, or any other device capable of executing and responding to instructions.

The processing device may execute an operating system (OS) and one or more software applications running on the operating system. In addition, the processing device may also access, store, operate, process, and generate data in response to the execution of the software. Sometimes it is described such that one processing device is used for convenience of understanding, but those skilled in the art will recognize that the processing device may include a plurality of processing elements and/or a plurality of types of processing elements.

For example, the processing device may include a plurality of processors, or include one processor and one controller. In addition, other processing configurations with such as parallel processors are also possible. The software may include a computer program, a code, an instruction, or a combination of one or more thereof, and may be configured to enable the processing device to operate as desired or to instruct the processing device independently or collectively.

In order to be interpreted by or to provide instructions or data to the processing device, software and/or data may be embodied in any type of machine, component, physical device, virtual equipment, computer storage medium, or computer storage device. Software may be distributed over networked computer systems, and stored or executed in a distributed manner. Software and data may be stored in one or more computer-readable recording media.

The methods according to the exemplary embodiments may be implemented in the form of program instructions that may be executed through various computer means, and may be recorded in a computer-readable media. The computer-readable media may include program instructions, data files, data structures, and the like alone or in combination thereof. The program instructions recorded on the media may be designed and configured specifically for the exemplary embodiments or may be publicly known and available to those skilled in the art regarding computer software.

Examples of the computer-readable recording media include: magnetic media, such as a hard disk, a floppy disk, and a magnetic tape; optical media, such as a compact disc read-only memory (CD-ROM), a digital versatile disc (DVD), etc.; and hardware devices specially configured to store and perform program instructions, for example, a read-only memory (ROM), a random access memory (RAM), a flash memory, etc. Examples of the computer instructions include not only machine language code generated by a compiler, but also high-level language code executable by a computer using an interpreter or the like. The hardware device described above may be configured to operate by one or more software modules to perform the operations of the exemplary embodiments, and vice versa.

As described above, although the exemplary embodiments have been described with reference to the limited exemplary embodiments and drawings, various modifications and variations are possible from the above description by those skilled in the art. For example, appropriate results may be achieved even when the described techniques are performed in a different order than that of the described method, and/or the described components of the system, structure, device, circuit, and the like are coupled to each other or combined in a different form than the described method, or replaced or substituted by other components or equivalents. Therefore, other implementation, other exemplary embodiments, and equivalents to the claims also fall within the scope of the following claims.

What is claimed is:

1. A method of modeling characteristics of a CMOS transistor in cryogenic conditions on the basis of a PSP model, the method comprising:
receiving a process design kit (PDK) comprising device information and process information, which are required for designing and implementing an integrated circuit;
extracting at least one parameter for modeling a prediction model for predicting characteristic values of a device comprised in the integrated circuit in the cryogenic conditions from the PDK on the basis of the PSP model; and
modeling the prediction model by adjusting the at least one parameter, so as to predict the characteristic values of the device in the cryogenic conditions.

2. The method of claim 1, wherein the device is the complementary metal-oxide-semiconductor (CMOS) transistor.

3. The method of claim 1, wherein the model is the PSP model and is configured to perform steps comprising:
performing geometry scaling for setting global parameters;
modeling a stress model by setting stress parameters;
modeling a well proximity effect model by setting well proximity effect parameters;
performing temperature scaling by setting local parameters; and
predicting the characteristic values of the device by inputting terminal voltages into equations for the model.

4. The method of claim 3, wherein the extracting of the at least one parameter comprises:
extracting at least one first parameter dependent on geometric properties of the device among the parameters utilized in the PSP model; and
extracting at least one second parameter dependent on temperature properties of the device among the parameters utilized in the PSP model.

5. The method of claim 4, wherein the modeling of the prediction model comprises:
adjusting the first and second parameters so as to be suitable for predicting the characteristic values of the device in the cryogenic conditions; and
implementing the performing of the geometry scaling, the modeling of the stress model, the modeling of the well proximity effect model, and the performing of the temperature scaling on the basis of the adjusted first and second parameters.

6. The method of claim 3, wherein the extracting of the at least one parameter comprises:
extracting device characteristics that are affected and changed by the cryogenic conditions;
extracting at least one third parameter dependent on the characteristics among the parameters utilized in the PSP model;
adjusting the third parameters so as to be suitable for predicting the characteristic values of the device in the cryogenic conditions; and
implementing the performing of the geometry scaling, the modeling of the stress model, the modeling of the well proximity effect model, and the performing of the temperature scaling on the basis of the adjusted third parameters.

7. A system for modeling characteristics of a CMOS transistor in cryogenic conditions on the basis of a PSP model, the system comprising:
at least one processor for implementing the system,
wherein the at least one processor is configured to receive a process design kit (PDK) comprising device information and process information, which are required for designing and implementing an integrated circuit, extract at least one parameter for modeling a prediction model for predicting characteristic values of a device comprised in the integrated circuit in the cryogenic conditions from the PDK, and model the prediction model by adjusting the at least one parameter, so as to predict the characteristic values of the device in the cryogenic conditions.

8. A computer-readable recording medium, comprising:
a program recorded thereon for executing a method for modeling characteristics of a CMOS transistor in cryogenic conditions on the basis of a PSP model of claim 1.

9. A method for simulating and correcting characteristics of a CMOS transistor in cryogenic conditions on the basis of a PSP model, the method comprising:
receiving a process design kit (PDK) comprising device information and process information, which are required for designing and implementing an integrated circuit;
extracting at least one parameter for modeling a prediction model capable of simulating and correcting a geometry dependent effect according to changes in characteristic values of a device comprised in the integrated circuit in the cryogenic conditions from the PDK on the basis of the PSP model; and
modeling the prediction model by adjusting the at least one parameter, so as to simulate and correct a geometry dependent effect in the cryogenic conditions.
